(19) United States
(12) Patent Application Publication
(10) Pub. No.: US 2021/0149544 A1
(43) Pub. Date: May 20, 2021

(54) INFORMATION PROCESSING APPARATUS, INFORMATION PROCESSING METHOD, AND PROGRAM

(71) Applicant: SONY CORPORATION, Tokyo (JP)

(72) Inventors: Masanori MATSUSHIMA, Tokyo (JP); Masao KONDO, Tokyo (JP); Hirotaka TAKO, Tokyo (JP); Hiroaki YOKOTA, Tokyo (JP)

(73) Assignee: Sony Corporation, Tokyo (JP)

(21) Appl. No.: 17/042,717

(22) PCT Filed: Mar. 1, 2019
(86) PCT No.: PCT/JP2019/008042

§ 371 Date: Sep. 28, 2020

(30) Foreign Application Priority Data
Apr. 6, 2018 (JP) 2018-074030

(51) Int. Cl. G06F 3/0481; G06F 3/0485; G01B 11/25; G06F 3/0482

(52) U.S. Cl. CPC G06F 3/04815; G06F 3/0482; G01B 11/2518; G06F 3/0485

(57) ABSTRACT

An information processing apparatus according to an embodiment of the present technology includes a storage section and a display control section. The storage section stores first content information about physical content arranged in a first area and second content information about electronic content. The display control section respectively controls a projection of light on the physical content and a displaying of an image relating to the electronic content on a second area corresponding to the first area on the basis of the stored first and second content information.

### TECHNICAL FIELD

The present technology relates to an information processing apparatus applicable to a presentation of content such as a book and music, an information processing method, and a program.

### BACKGROUND ART

In an information processing system described in Patent Literature 1, a screen for selecting content provided with electronic data can be represented in a virtual world in which objects representing any content are arranged in a display rack. A display area is allowed to be moved with respect to the display rack and a desirable object is selected to start a displaying of a content body, and it is possible to change statuses of the objects such as a rearrangement and a change in arrangement/orientation of the objects.

This makes it possible to create the display rack that suits personal preference such as placing the objects so that packages of favorite design are clearly looked or viewing many objects at once by placing them in a direction to narrow a width. As a result, it makes possible to provide both of an improvement of access efficiency and creation of a preference selection screen by taking circumstances of respective users into consideration (Patent Literature 1, paragraph [0095], FIG. 5, etc.).

### CITATION LIST

### Patent Literature

Patent Literature 1: Japanese Patent Application Laid-open No. 2014-59758

### DISCLOSURE OF INVENTION

### Technical Problem

Thus, it needs a technology capable of improving user access efficiency for variety of content such as books.

In view of the above circumstances, it is an object of the present technology to provide an information processing apparatus that can improve access efficiency for content, an information processing method, and a program.

### Solution to Problem

In order to achieve the above object, an information processing apparatus according to an embodiment of the present technology includes a storage section and a display control section.

The storage section stores first content information about physical content arranged in a first area and second content information about electronic content.

The display control section respectively controls a projection of light on the physical content and a displaying of an image relating to the electronic content on a second area corresponding to the first area on the basis of the stored first and second content information.

In this information processing apparatus, the first content information about the physical content and the second content information about the electronic content are stored. The projection of light on the physical content arranged in the first area and the displaying of the image relating to the electronic content on the second area corresponding to the first area are respectively controlled. Thus, it becomes possible to improve access efficiency for content with respect to both of the physical content and the electronic content.

The physical content may be arranged in a predetermined space. In this case, the first area and the second area may be areas within the predetermined space. The image relating to the electronic content may be an image that shows virtual content expressed as an image of a same type as the physical content in the predetermined space. The display control section may respectively control the projection of light on the physical content in the predetermined space and a projection of an image relating to the electronic content in the predetermined space.

The information processing apparatus may further include an acceptance section that accepts an instruction of a user with respect to the physical content and the electronic content. In this case, the display control section may respectively control the projection of light on the physical content and the displaying of the image relating to the electronic content on the basis of the accepted instruction of the user.

The acceptance section may accept a selection instruction of content. In this case, the display control section may control the projection of light on the physical content such that the selected physical content is emphasized when the physical content is selected, and may control the displaying of the image relating to the electronic content such that the selected electronic content is emphasized when the electronic content is selected.

The acceptance section may accept a search instruction of content. In this case, the display control section may control the projection of light on the physical content such that the searched physical content is emphasized, and may control the displaying of the image relating to the electronic content such that the searched electronic content is emphasized.

The information processing apparatus may further include an output section that outputs list information for displaying a list including the physical content and the electronic content. In this case, the acceptance section may accept the instruction of the user on the basis of an operation of the user on the list displayed on a display.

The list may be a list displayed in a status in which the physical content and the electronic content are mixed.

The acceptance section may accept an instruction to change content to be selected on the basis of a scrolling operation on the list. In this case, the display control section may respectively control the projection of light on the physical content and the displaying of the image relating to the electronic content so as to follow the change of the content to be selected.

The acceptance section may accept the instruction of the user on the basis of an action of the user with respect to the physical content arranged in the first area and an image relating to the electronic content displayed in the second area.

The acceptance section may accept, on the basis of an action of specifying the physical content arranged in the first area, a selection instruction of the specified physical content, and may accept, on the basis of an action of specifying the image relating to the electronic content displayed in the second area, a selection instruction of the electronic content corresponding to the specified image.

The display control section may display detailed information about the electronic content corresponding to the specified image in the second area.

The output section may output the list information such that the accepted instruction of the user on the basis of the action of the user is reflected in the list.

The first and second content information may be stored in the storage section in a data format including at least information about a position where content is arranged, information indicating whether or not the content is physical content or electronic content, and meta information about content. In this case, the first content information may include information about a position where the physical content is arranged, information indicating the physical content, and meta information about the physical content. In addition, the second content information may include information about a position where the image relating to the electronic content is displayed, information indicating the electronic content, and meta information about the electronic content.

The information processing apparatus may further include a management section that manages the first and second content information.

The management section may detect an arrangement status of the physical content on the basis of a captured image in which the first area is captured, and may update the first content information on the basis of the detected arrangement status.

The management section may acquire information about an acquisition status of the electronic content from a server of a network service that provides the electronic content, and may update the second content information on the basis of information about the acquired acquisition status.

The electronic content may correspond to the physical content.

The physical content may be a book, a case of a recording medium, or a tag.

An information processing method according to an embodiment of the present technology is executed by a computer system, and includes storing first content information about physical content arranged in a first area and second content information about electronic content.

On the basis of the stored first and second content information, a projection of light on the physical content and a displaying of an image relating to the electronic content on a second area corresponding to the first area are respectively controlled.

A program according to an embodiment of the present technology causes a computer system to perform the following steps:

storing first content information about physical content arranged in a first area and second content information about electronic content;

respectively controlling a projection of light on the physical content and a displaying of an image relating to the electronic content on a second area corresponding to the first area on the basis of the stored first and second content information.

### Advantageous Effects of Invention

As described above, according to the present technology, it becomes possible to improve access efficiency for content. Note that the effect described here is not necessarily limitative, and any of the effects described in the present disclosure may be provided.

### BRIEF DESCRIPTION OF DRAWINGS

FIG. 1 is a schematic diagram showing an example configuration of a content presentation system according to an embodiment of the present technology.

FIG. 2 is a schematic diagram showing a configuration example of a bookshelf.

FIG. 3 is a schematic diagram showing an arrangement example of a projector.

FIG. 4 is a block diagram showing an example of a functional configuration of a system controller.

FIG. 5 is a diagram showing examples of book information stored in a local database.

FIG. 6 is a diagram showing a configuration example of a book list screen.

FIG. 7 is a flow chart showing an example of a content presentation.

FIG. 8 is a schematic diagram showing a configuration example of a book list screen when a real book is selected via a book list.

FIG. 9 is a schematic diagram showing an example of projection of light on a bookshelf when a real book is selected via a book list.

FIG. 10 is a schematic diagram showing a configuration example of a book list screen in a case where an electronic book is selected via a book list.

FIG. 11 is a schematic diagram showing an example of a projection of a virtual image in a case where an electronic book is selected via a book list.

FIG. 12 is a schematic diagram showing a configuration example of a book search screen.

FIG. 13 is a schematic diagram showing a configuration example of a search result screen displayed on a touch panel.

FIG. 14 is a schematic diagram showing an example of a projection of light and an image on a bookshelf.

FIG. 15 is a schematic diagram showing an example of a projection of light and an image corresponding to a scroll operation on a book list of a book list screen.

FIG. 16 is a flowchart showing an example of processing according to an action of a user with respect to a bookshelf.

FIG. 17 is a schematic diagram showing an example of a projection of light and an image on a bookshelf according to an action of a user with respect to a bookshelf 10.

FIG. 18 is a flowchart showing an example of management of a local database with respect to a real book.

FIG. 19 is a flowchart showing an example of management of a local database relating to an electronic book.

FIG. 20 is a schematic diagram for explaining a content presentation system according to another embodiment.

### MODES FOR CARRYING OUT THE INVENTION

Embodiments according to the present technology will now be described below with reference to the drawings.

[Configuration of Content Presentation System]

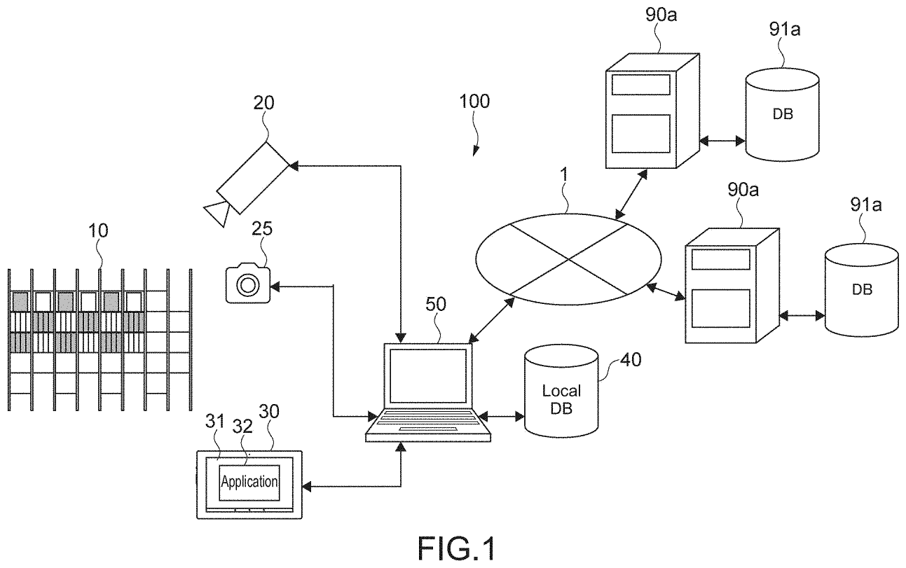

FIG. 1 is a schematic diagram showing an example configuration of a content presentation system according to an embodiment of the present technology. A content presentation system 100 includes a projector 20, a camera 25, a tablet terminal 30, a local database 40, and a system controller 50.

The projector 20 is capable of generating and projecting an image. In the embodiment, the projector 20 is set toward a bookshelf 10. The projector 20 is capable of projecting light on the bookshelf 10. Here, the projection of light means that the light is outputted toward a target from a light source. The light may be direct light or indirect light. It may also be light having a color, light modulated by a light modulator, light visible to a user as an image such as a pattern or a painting. Otherwise, any form of light may be projected.

A specific configuration of the projector 20 is not limited. A light source, illumination optics, an image generating element, projection optics, the number of pixels of the projected image, etc. are not limited, and any projector may be used. For example, a laser projector in which a laser light source is mounted, a short focus projector in which a short focus optical system is mounted, a 4K high-definition projector or the like may be used as appropriate.

The camera 25 is set to be capable of capturing the bookshelf 10 and a periphery of the bookshelf 10. The camera 25 is capable of capturing both a still image and a moving image. For example, a digital camera including an image sensor such as a complementary metal-oxide semiconductor (CMOS) sensor and a charge coupled device (CCD) sensor is used as the camera 25. Moreover, any camera may be used.

The tablet terminal 30 has a touch panel 31 which functions as a display. The tablet terminal 30 includes hardware, such as a CPU, a ROM, a RAM, and an HDD, that is necessary to configure a computer. By loading and executing a program according to the present technology in which the CPU is recorded in advance in the ROM or the like to the RAM, a variety of processing relating to the content presentation system 100 is executed. For example, when an operation is input to the touch panel 30 or various buttons (not shown) of the tablet terminal 30, an operation signal corresponding to the operation is generated and transmitted to the system controller 50.

The user activates an application 32 for using the content presentation system 100. Thus, as will be described later, it becomes possible to execute a seamless operation on a real book that physically exists and an electronic book. A specific configuration of the tablet terminal 30 is not limited and may be arbitrarily configured. Also, a PDA (PersonalDigital Assistants) such as a smart phone may be used.

The local database 40 is constructed by any storage device. In the present embodiment, the local database 40 stores book information including physical book information about the real book and electronic book information about the electronic book.

The system controller 50 inclusively controls the content presentation system 100. As shown in FIG. 1, the system controller 50 is communicably connected to the projector 20, the camera 25, and the tablet terminal 30. A connection form of respective devices is not limited, and a wireless LAN communication such as Wi-Fi or near field communication such as Bluetooth (registered trademark) is used, for example.

In addition, the system controller 50 is configured to be accessible to the local database 40 and is capable of performing various processing such as registering, changing, and deleting book information on the local database 40. Further, the system controller 50 can read out the book information stored in the local database 40 and output the book information to an external device such as the tablet terminal 30.

The local database 40 may be built in the system controller 50 or in other storage device. In any case, in the present embodiment, an embodiment of the information processing apparatus according to the present technology is realized by the system controller 50 and the storage device for constructing the local database 40. The local database 40 may also be an embodiment of the storage section in accordance with the present technology.

The system controller 50 is communicably connectable to an external server or the like via a network 1. In the present embodiment, the system controller 50 is communicably connected to servers 90a and 90b of a network service providing the electronic book. Each of the servers 90a and 90b is configured to be accessible to databases 91a and 91b in which service use information such as information about providable electronic books, personal information about service users, and purchase information is stored.

In FIG. 1, two servers 90a and 90b are shown, but the number of network services that provide electronic books is not limited. Of course, only one network service may be used.

The network 1 is constructed by, for example, the Internet or a wide area communication network. Further, any wide area network (WAN), any local area network (LAN), or the like may be used, and a protocol used to build the network 1 is not limited. Note that the network 1 may be used for connection with the projector 20, the camera 25, the tablet terminal 30, and the like.

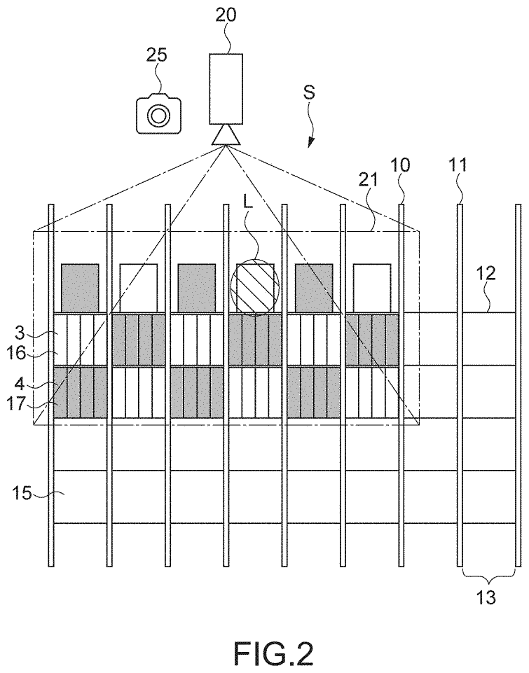

FIG. 2 is a schematic diagram showing a configuration example of the bookshelf 10. The bookshelf 10 is arranged in a predetermined space (real space) S such as a room, and has a plurality of column portions 11 and a plurality of shelf plates 12. The plurality of column portions 11 is arranged at substantially equal intervals in a horizontal direction when viewed from a front of the bookshelf 10. Each of the column portions 11 has a plate shape, and surfaces of the column portions 11 are arranged so as to face each other along the horizontal direction.

The plurality of the shelf plates 12 is arranged along a substantially horizontal direction in a gap area 13 between the surfaces facing each other of the adjacent column portions 11. The shelf plates 12 are arranged in one gap area 13 so as to be arranged at substantially equal intervals in a vertical direction. In addition, the shelf plates 12 are arranged so that the shelf plates 12 adjacent to each other in the horizontal direction are aligned at substantially the same height.

Accordingly, a plurality of rectangular areas 15 each of which has a substantially equal size to each other is formed in a grid shape within the bookshelf 10, arranged in the horizontal direction and the vertical direction. Incidentally, the areas 15 above the shelf plate 12 arranged at the highest position are open upward.

The plurality of areas 15 of the bookshelf 10 may also be referred to as content presentation areas. By using the content presentation area as a reference, a projection area 21 of the projector 20 and a capturing range (not shown) of the camera 25 are set.

In the example shown in FIG. 2, the projection area 21 of the projector 20 is set in a part of the areas of the bookshelf 10. Of course, it is also possible to set the projection area 21 of the projector 20 so as to entirely cover the bookshelf 10.

In the present embodiment, an arrangement area 16 in which the physically existing real book 3 is arranged is set for the plurality of areas 15 of the bookshelf 10. Further, a display area 17 in which a virtual image 4 representing the electronic book is displayed is set for the plurality of areas 15. As a matter of course, the arrangement area 16 and the display area 17 are areas within the predetermined space S. Therefore, the real book 3 will be arranged in a predetermined space S.

The projector 20 individually projects the virtual image 4 of the electronic book one by one on the display area 17 of the bookshelf 10. In addition, the projector 20 projects light individually to the real book 3 one by one arranged in the arrangement area 16 of the bookshelf 10. In the example shown in FIG. 2, a spotlight L is applied as illumination light to the book 3 arranged at the center of the uppermost portion.

In the present embodiment, the system controller 50 outputs an instruction for projecting the virtual image 4 on the projector 20 on the basis of the electronic book information stored in the local database 40. The projector 20 generates an image light constituting the virtual image 4, and projects the image light on the predetermined position of the display area 17 on the basis of an instruction of the system controller 50.

The virtual image 4 is an image showing a virtual book which is represented as an image of a same type as that of the real book 3 in the predetermined space S. The virtual image 4 can also be referred to as an image in which an electronic book is represented in a manner substantially equal to that of the real book 3. In the present embodiment, the real book 3 is arranged in the arrangement area 16 so that a cover and a back cover face forward. Thus, virtual images 4 of the cover and the back cover are displayed as the virtual image 4.

As the virtual image 4, for example, an image obtained by capturing the real book corresponding to an electronic book is used. Of course, it is not limited thereto and in a case where a real book corresponding to an electronic book does not exist or the like, any image in which an electronic book is virtually represented as a real book may be used as the virtual image 4.

In addition, in the present embodiment, the system controller 50 outputs an instruction for projecting light on the real book 3 to the projector 20 on the basis of the physical book information stored in the local database 40.

The projection of light on the real book 3 includes a projection of illumination light (spotlight L) for illuminating the real book 3 as shown in FIG. 2. It is not limited thereto, and the projection of light on the real book 3 includes a projection of light of any form such as the image light constituting a predetermined image such as a character design, colored light to which any color is applied, gradated light, light with a dynamic change in color, shape, or the like. On the other hand, it is also possible to make the projection of light of any form on the real book 3 as illumination on the real book 3.

The projector 20 generates the light of any form on the basis of the instruction from the system controller 50, and projects the light on the predetermined real book 3. For example, the image light in which a predetermined area is displayed in white or the like can be used as the illumination light. Of course, The method of generating the light of any form of light is not limited.

It will be appreciated that the projection of the virtual image 4 and the projection of light may be performed simultaneously. Note that, in an initial condition, the projection of light on the real book 3 is not performed, and only the projection of the virtual image 4 of the electronic book is performed.

In the present disclosure, in each drawing, the real book 3 is shown in white, and the virtual image 4 of the electronic book is shown in gray.

As shown in FIG. 2, in the uppermost arrangement area 16, the real book 3 is arranged so that the cover faces forward. In the other arrangement area 16, the real book 3 is arranged so that the back cover is facing forward.

The virtual image 4 of the cover is displayed in the uppermost display area 17, and the virtual image 4 of the back cover is displayed in the other display areas 17, substantially in the same manner as the arrangement of the real book 3. It is needless to say that it is not limited to such an arrangement and display, and for example, a virtual image of a cover or a spread page of a book may be displayed.

In the present embodiment, the arrangement area 16 and the display area 17 are set so as to alternately align along the horizontal direction and the vertical direction. That is, the arrangement area 16 and the display area 17 are set so as to have an arrangement similar to a checker pattern. This makes it possible to seamlessly handle the real book 3 and the electronic book virtually represented by the virtual image 4, and provides high usability.

In the present embodiment, the real book 3 corresponds to the physical content, and the arrangement area 16 corresponds to the first area. The electronic book corresponds to the electronic content, and the virtual image 4 corresponds to the image relating to the electronic content. The display area 17 corresponds to the second area corresponding to the first area.

Hereinafter, the physical content and the electronic content may be collectively referred to as content. In addition, the real book 3 and the electronic book may be collectively referred to as a book. That is, the content is a concept that includes both the physical content and the electronic content. In addition, the book is a concept including both the real book 3 and the electronic book.

A correspondence relationship between the arrangement area 16 (first area) and the display area 17 (second area) is not limited and may be arbitrarily set. Typically, the display area 17 is set in an area different from the arrangement area 16 in accordance with the arrangement of the arrangement area 16. Any configuration such as a configuration in which the arrangement area 16 and the display area 17 are divided into left and right, or up and down, a configuration in which they are alternately set in a concentric shape, or the like may be employed. Also, it is not limited to the case where the arrangement area 16 and the display area 17 are completely different areas, a configuration such that a part overlaps may be employed.

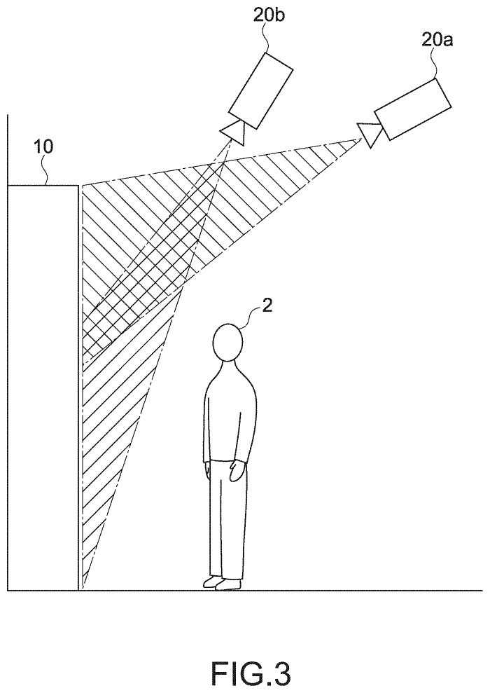

FIG. 3 is a schematic diagram showing an arrangement example of the projector 20. As shown in FIG. 3, a plurality of projectors 20a and 20b may cooperate to perform the projection of light and the image on the content presentation area.

In the example shown in FIG. 3, for the area above the bookshelf 10, a projector 20a set at a predetermined distance from the bookshelf 10 performs the projection of light and the image. Therefore, for the area above the bookshelf 10, the projection is performed from behind a user 2 standing in front of the bookshelf 10.

For the area below the bookshelf 10, the projection of light and the image is performed at a steep angle by a projector 20b arranged between the bookshelf 10 and the projector 20a. Therefore, for the area below the bookshelf 10, the projection is performed at a steep angle from above the user 2 standing in front of the bookshelf 10.

For example, by employing such a configuration, it is possible to set the projection area in the entire area of the bookshelf 10 while preventing a shadow of the user 2 from being generated. Of course, it is not limited to the configuration shown in FIG. 3, an arrangement configuration of the projector 20 may be arbitrarily set on the basis of a size of the bookshelf 10 (size of content presentation area), a moving range of the user 2 accessing the bookshelf 10, an environment in which the bookshelf 10 is arranged, and the like.

Further, a projection mechanism for projecting light on the real book 3 and the projector 20 (projection mechanism) for projecting the virtual image 4 may be separately realized.

An arrangement configuration of the camera 25 is also not limited and may be arbitrarily set. For example, a plurality of cameras 25 may cooperate to capture the entire bookshelf 10 (content presentation area).

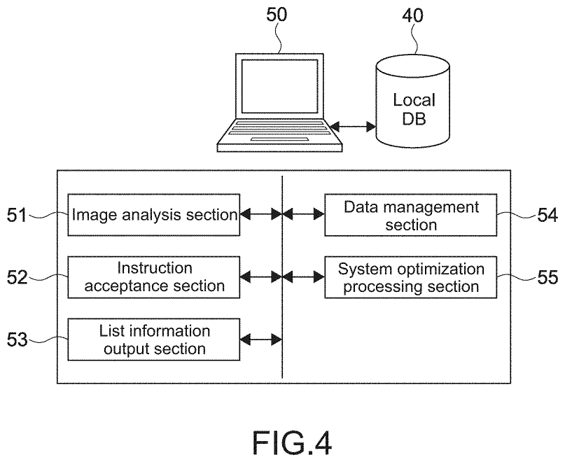

FIG. 4 is a block diagram showing an example of a functional configuration of the system controller 50.

The system controller 50 includes hardware, such as a CPU, a ROM, a RAM, and an HDD, that is necessary to configure a computer. When the CPU loads and executes the program according to the present technology recorded in advance in the ROM or the like, each block shown in FIG. 4 is configured and the information processing method according to the present technology is executed.

The system controller 50 can be realized by any computer such as a personal computer (PC). Of course, hardware such as an FPGA or an ASIC may be used. In order to realize each block shown in FIG. 4, dedicated hardware such as an integrated circuit (IC) may be used.

The program is installed on the system controller 50 through, for example, various recording media. Alternatively, the installation of the program may be performed via, for example, the Internet.

As shown in FIG. 4, the system controller 50 includes an image analysis section 51, an instruction acceptance section 52, a list information output section 53, a data management section 54, and a system optimization processing section 55.

The image analyzing section 51 analyzes a captured image that is captured by the camera 25. In the present embodiment, it is possible to detect the arrangement status of the real book 3 arranged on the bookshelf 10 by the image analysis section 51. The arrangement status of the real book 3 includes, for example, a position of the real book 3 and the number of the real books 3 arranged in the bookshelf 10. Of course, it is not limited thereto.

The image analysis section 51 is capable of detecting an action (gesture) of the user 2 with respect to the bookshelf 10. For example, the image analysis section 51 is capable of detecting the action of the user 2 with respect to the real book 3 arranged in the arrangement area 16. For example, it is possible to detect various actions such as touching the real book 3, pointing to the real book 3, taking out the real book 3, returning the real book 3 to the bookshelf, moving the real book 3 to another position, etc.

The image analysis section 51 is capable of detecting the action of the user 2 with respect to the virtual image 4 of the electronic book displayed in the display area 17. For example, it is possible to detect various actions such as touching the virtual image 4 (superimposing hand or the like), pointing to the virtual image 4, doing an action of taking out with respect to the virtual image 4, and the like.

The arrangement status of the real book 3 and the method of detecting the action of the user 2 are not limited, and any image analysis technology may be used. For example, any machine-learning algorithm using a DNN (Deep Neural Network) or the like may be used. For example, by using AI (artificial intelligence) or the like for performing deep learning, it is possible to improve a detection accuracy of the arrangement status and the action.

Note that the machine learning or the like may be used to perform other processing described in the present disclosure, such as processing performed by the system optimization processing section 55 or the like. This makes it possible to improve the accuracy in performing various processes relating to content presentation.

The instruction acceptance section 52 accepts an instruction of the user 2 to the real book 3 and the electronic book. For example, as the instruction of the user 2, a book selection instruction, a book search instruction, an instruction to change a book to be selected, and the like are accepted. Of course, it is possible to accept any other instructions.

In the present embodiment, the book selection instruction corresponds to content selection instruction, and the book search instruction corresponds to content search instruction. In addition, the instruction to change the book to be selected corresponds to the instruction to change the content to be selected.

The instruction acceptance section 52 is capable of accepting the instruction of the user 2 on the basis of the operation of the user 2 with respect to the tablet terminal 30. Specifically, the instruction acceptance section 52 receives an operation signal output from the tablet terminal 30 in response to an operation with respect to the tablet terminal 30. On the basis of the received operation signal, the instruction input by the user 2 is determined and accepted.

In addition, the instruction acceptance section 52 is capable of accepting the instruction of the user 2 on the basis of the action of the user 2 with respect to the bookshelf 10. For example, the instruction of the user 2 is accepted on the basis of the action of the user 2 with respect to the virtual image 4 of the real book 3 arranged in the arrangement area 16 and the electronic book displayed in the display area 17.

Specifically, the instruction acceptance section 52 determines and accepts the instruction input by the user 2 on the basis of the action of the user 2 with respect to the bookshelf 10 detected by the image analysis section 51. The determination of the instruction of the user 2 on the basis of the action of the user 2 is executed by, for example, referring to the table information stored in advance. Of course, it is not limited to this method, and any method may be employed, and the machine learning or the like may be used.

The list information output section 53 outputs the list information for displaying a book list including the real book 3 and the electronic book. For example, the list information output section 53 transmits the list information for displaying the book list on the touch panel 31 of the tablet terminal 30 to the tablet terminal 30. The tablet terminal 30 generates the book list on the basis of the list information, and displays the book list on the touch panel 31.

The list information for displaying the book list is, for example, information including the book information (physical book information, electronic book information) that is organized in the local database 40. Note that the book list itself is also included in the list information for displaying the book list. Therefore, the list information output section 53 may generate the book list and output the book list to an external device such as the tablet terminal 30.

The data management section 54 manages the book information (physical book information, electronic book information) stored in the local database 40. The data management section 54 performs various update processes such as registration, change, and deletion of the book information.

The system optimization processing section 55 executes overall control so that the content presentation system 100 executes an optimal action. The system optimization processing section 55 controls the projection of image and the projection of light by the projector 20. The system optimization processing section 55 appropriately controls the position and the size of the projection area of the projector 20, content of the image to be projected, the projection position of the image, the projection position of the light or the like.

As will be described later, in the present embodiment, the system optimization processing section 55 respectively controls the projection of light on the real book 3 and the displaying of the virtual image 4 of the electronic book on the display area 17 corresponding to the arrangement area 16 on the basis of the physical book information and the electronic book information stored in the local database 40. That is, the system optimization processing section 55 respectively controls the projection of light on the real book 3 in the predetermined space S and the projection of the virtual image 4 of the electronic book in the predetermined space S.

In addition, the system optimization processing section 55 controls capturing by the camera 25. The system optimization processing section 55 is capable of controlling various parameters about capturing such as the position and size of the captured area (angle of view), the frame rate of the moving image, and the like.

In addition, the system optimization processing section 55 is capable of controlling the output of the list information by the list information output section 53 and the management of the book information by the data management section 54. That is, in the present embodiment, the respective blocks of the projector 20, the camera 25, the list information output section 53, and the data management section 54 are operated on the basis of an instruction of the system optimization processing section 55.

In the present embodiment, the image analysis section 51 and the instruction acceptance section 52 function as the acceptance section. The book list 61 corresponds to the list, and the list information output section 53 functions as the output section. The data management section 54 functions as the management section. The system optimization processing section 55 functions as the display control section. Further, by cooperating the respective blocks as appropriate, the reception section, the output section, the management section, and the display control section are realized, respectively.

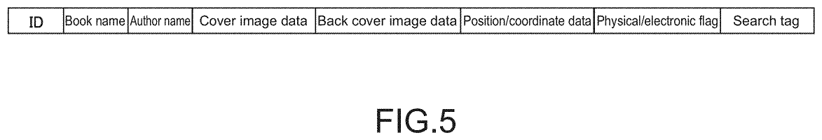

FIG. 5 is a diagram showing examples of the book information stored in the local database 40. In the present embodiment, the following information is stored as the book information.

“ID” . . . Identity information unique to content presentation system 100

“Book name” . . . Title of book

“Author name” . . . Name of author

“Cover image data” . . . Image data of cover of book

“Back cover image data” . . . Image data of back cover of book

“Position/coordinate data” . . . Position information in which real book 3 is arranged, and position information in which virtual image 4 is displayed

“Physical/electronic flag” . . . Flag to identify physical content or electronic content (e.g. “0”, “1”, etc.)

“Search tag” . . . Information referenced when searching for books (e.g., “genre”, “publisher”, “content information”, etc.)

In the “physical/electronic flag”, the book information as a flag of the physical content becomes the physical book information relating to the real book 3. In the “physical/electronic flag”, the book information as a flag of the electronic content becomes the electronic book information relating to the electronic book.

In the present embodiment, the physical book information corresponds to the first content information relating to the physical content. The “position/coordinate data” and “physical/electronic flag” included in the physical book information correspond to the information about the position where the physical content is arranged and the information that indicates the physical content. In addition, the “book name”, “author name”, “cover image data”, “back cover image data” and “search tag” included in the physical book information correspond to the meta information relating to the physical content.

The electronic book information corresponds to the second content information relating to the electronic content. The “position and coordinate data” and “physical/electronic flag” included in the electronic book information correspond to the information about the position where the virtual image 4 of electronic content is displayed and the information indicating the electronic content. The “book name”, “author name”, “cover image data”, “back cover image data” and “search tag” included in the electronic book information correspond to the meta information relating to electronic content.

Thus, in the present embodiment, the physical book information and the electronic book information are stored in the local database 40 in a data format that includes at least the information about the position where the content is positioned, information indicating whether or not the content is the physical content or the electronic content, and the meta information about the content. Thus, by setting common parts of the data formats between the physical book information and the electronic book information, the real book 3 (physical content) and the electronic book (electronic content) can be managed collectively as data, and can be easily arranged side by side in the spatial S.

It does not mean that the first content information relating to the physical content and the second content information relating to the electronic content are not limited to the information shown in FIG. 5. Any other data may be stored as first and second content information.

[Book List]

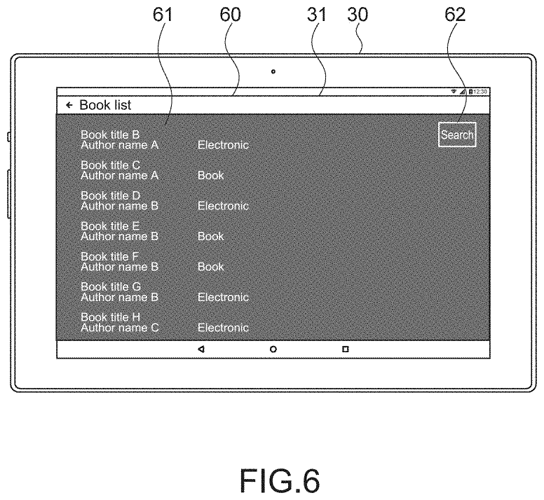

FIG. 6 is a diagram showing a configuration example of a book list screen. A book list screen 60 is a screen on which a book list 61 is displayed. In the example shown in FIG. 6, the book list 61 is displayed on the touch panel 31 of the tablet terminal 30.

For example, when a display instruction of the book list screen 60 (display instruction of book list 61) is input by the user 2, the list information output section 53 outputs the list information to the tablet terminal 30. The book list 61 is displayed on the touch panel 31 of the tablet terminal 30.

In the present embodiment, indices of respective books (real book and electronic book) are displayed in a list. The index of each book includes a book title, an author name, and information capable of discerning whether or not the book 3 is a real book or an electronic book. Note that the “book” in the index corresponds to the real book 3 and the “electronic” corresponds to the electronic book. Needless to say, the information about each book displayed in a list in the book list 61 is not limited and may be arbitrarily set.

As shown in FIG. 6, the book list 61 is a list displayed in a status in which real books 3 and electronic books are mixed. That is, the indices of the respective books are arranged in a predetermined sorting order without distinguishing between the real book 3 and the electronic book. In the example shown in FIG. 6, index information is arranged for each author name without distinguishing between a book and an electronic book.

The user 2 can check all books (real books 3 and electronic books) managed by the local database 40 by scrolling the book list 61. Since the book list 61 in which the real books 3 and the electronic books are mixed is displayed, the user 2 can seamlessly handle the real books 3 and the electronic books, and high usability can be achieved.

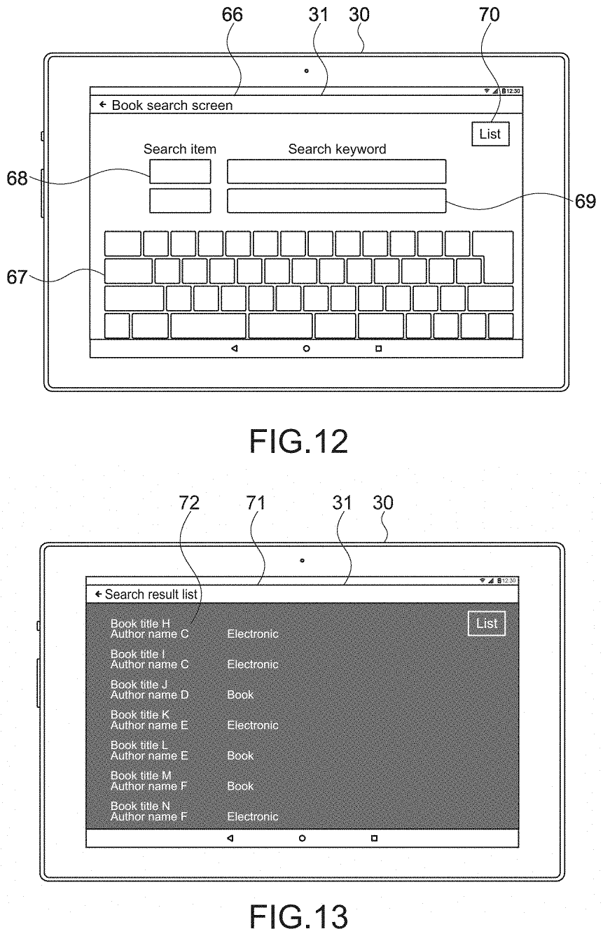

A search button 62 is arranged in the upper right corner of the book list screen 60. When the search button 62 is selected, a book search screen 66 (see FIG. 12) is displayed.

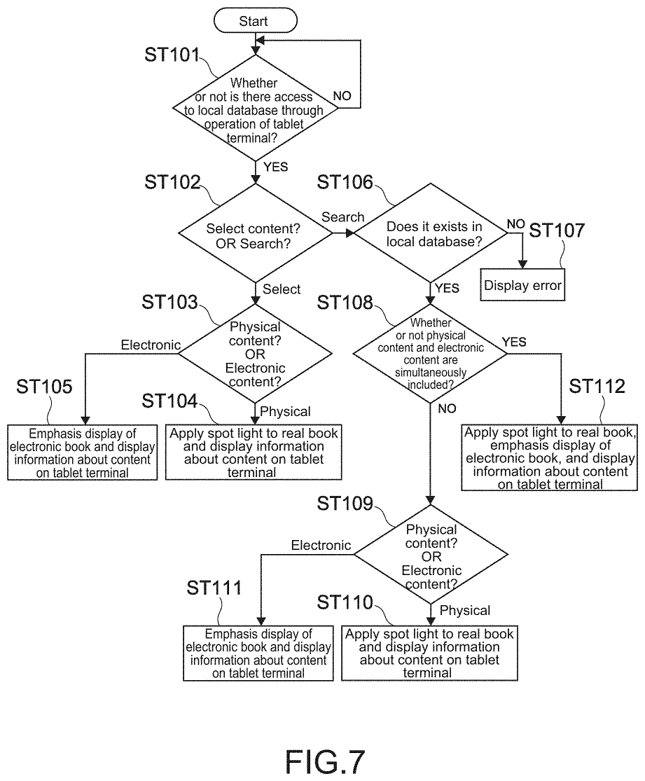

FIG. 7 is a flow chart showing an example of the content presentation. First, it is monitored whether or not there is access to the local database 40 through the operation of the tablet terminal 30 (Step 101). Here, as the access to the local database 40, a selection of books and a search of books will be described as an example. Therefore, in Step 101, the instruction acceptance section 52 monitors whether or not one of the book selection instruction and the book search instruction is accepted.

For example, a predetermined book (predetermined content) included in the book list 61 shown in FIG. 6 is selected by tapping or the like. Then, a selection instruction of the book is accepted, and the process proceeds from YES in Step 101 to Step 102 and proceeds to Step 103.

In Step 103, the system optimization processing section 55 determines whether or not the selected book is the real book 3 (physical content) or the electronic book (electronic content). This determination is performed, for example, by checking the “physical/electronic flag” included in the book information in the local database 40.

In a case where the selected book is the real book 3, information about the selected real book 3 is displayed on the touch panel 31 of the tablet terminal 30 (Step 104). In addition, the system optimization processing section 55 controls the projection of light on the selected real book 3 arranged on the bookshelf 10 on the basis of the “position/coordinate data” included in the book information about the local database 40.

Specifically, the projection of light on the real book 3 is controlled so that the selected real book 3 arranged on the bookshelf 10 is emphasized. In the present embodiment, the spotlight is applied to the selected real book 3 (also Step 104).

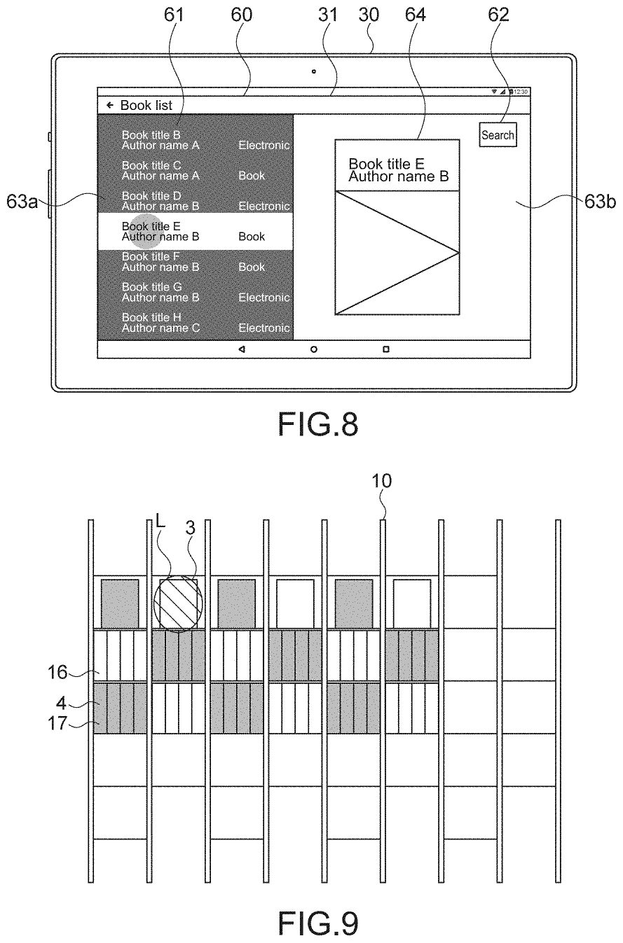

FIG. 8 is a schematic diagram showing a configuration example of the book list screen 60 in a case where the real book 3 is selected via the book list 61. FIG. 9 is a schematic diagram showing an example of the projection of light on the bookshelf 10 in a case where the real book 3 is selected via the book list 61. In FIG. 9, the projector 20, the camera 25, and the projection area 21 are not shown.

The user 2 selects a desired book from the book list 61. The selected book is emphasized so as to be emphasized and is moved to a substantially center position in the vertical direction of the touch panel 31. That is, the selected book is focused on the center.

The book list screen 60 is divided into left and right areas, and the book list 61 is displayed as it is in a left area 63a. In a right area 63b, detailed information 64 of the selected real book 3 is displayed.

In the present embodiment, the cover image of the selected real book 3 is displayed as the detailed information 64. Of course, it is not limited thereto, and any information such as the meta information about the real book 3 stored in the local database 40 may be displayed as the detailed information 64.

As shown in FIG. 9, with respect to the bookshelf 10, the projection of light on the real book 3 is controlled so that the book 3 of the selected real is emphasized. This makes it possible to easily grasp the position of the selected real book 3, and to improve the access efficiency to the real book 3.

Note that a specific light projection method to emphasize the real book 3 is not limited. It is not limited to the method of applying the spotlight L as shown in FIG. 9, and any projection method may be employed. For example, light is flashing, or large-sized circle light becomes gradually small and the spot light is applied to the real book 3. In addition, various projection methods can be employed, such as projection of light while changing color, projection of light with gradation, and the like.

In addition, the light projection method may be appropriately controlled in accordance with the position where the real book 3 is arranged. For example, in a case where the selected real book 3 is arranged at a position far from the user 2, the projection of light is controlled so that the degree of emphasis becomes high. This makes it possible to rapidly identify the position of the selected book and improve the access efficiency.

In Step 103 of FIG. 7, if the selected book is the electronic book, the information about the selected electronic book is displayed on the touch panel 31 of the tablet terminal (Step 105).

In addition, the system optimization processing section 55 controls the displaying of the virtual image 4 of the selected electronic book in the display area 17 of the bookshelf 10 on the basis of the “position/coordinate data” included in the book retribution in the local database 40. Specifically, the displaying of the virtual image of the selected electronic book is controlled so that the selected electronic book is emphasized (Step 105).

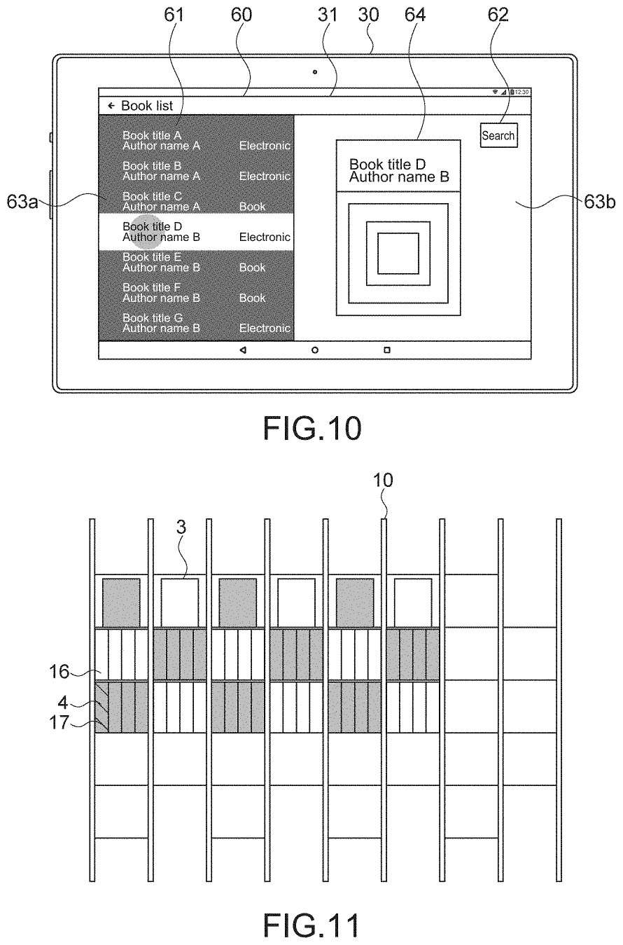

FIG. 10 is a schematic diagram showing a configuration example of the book list screen 60 in a case where the electronic book is selected via the book list 61. FIG. 11 is a schematic diagram showing an example of the projection the virtual image 4 in a case where the electronic book is selected via the book list 61.

The book list screen 60 has a configuration substantially equal to that when the real book 3 is selected. That is, in the left area 63a, the selected electronic book is focused at the center. In the right area 63b, the cover image of the electronic book is displayed as detailed information about the selected electronic book.

As shown in FIG. 11, the displaying of the virtual image 4 of the electronic book is controlled so that the selected electronic book is emphasized with respect to the bookshelf 10. For example, any emphasis displaying may be employed, such as flashing, changing color, enlarging size, etc., so that the virtual image 4 displayed in the initial status is emphasized. This makes it possible to easily grasp the position of the selected electronic book (position of virtual image 4) and to improve the access efficiency to the electronic book.

Incidentally, it is also possible to display the virtual image 4 of the selected electronic book at a position different from the position in the initial status. For example, the virtual image 4 of the selected electronic book is displayed at a position close to the user 2. This makes it possible to improve the access efficiency. Note that, in this case, the “position and coordinate data” of the electronic book information in the local database 40 is updated, as appropriate.

FIG. 12 is a schematic diagram showing a configuration example of the book search screen. The book search screen 66 includes a keyboard 67, an item selection section 68, and a search keyword input section 69. In the item selection section 68, search items such as “book name”, “author name”, and “publisher” are specified by, for example, a pull-down method. A search keyword is input to the search keyword input section 69 for each designated search item via the keyboard 67. After entering the search keyword, in a case where “Enter” is selected, the search processing starts.

Incidentally, in a case where the list button 70 arranged in the upper right corner of the book search screen 66 is selected, the book list screen 60 is displayed.

When the search operation is executed by the user 2, the instruction acceptance section 52 accepts a search instruction of the book (search instruction of content). In the flowchart of FIG. 7, the process proceeds from Step 102 to Step 106.

In Step 106, the system optimization processing section 55 determines whether or not the book satisfying the search condition exists in the local database 40. This determination is performed, for example, by referring to the meta information such as a “search tag” included in the book information in the local database 40.

If there is no book satisfying the search condition in the local database 40 (No in Step 106), error information indicating that the searched book does not exist is output, and an error is displayed on the touch panel 31 of the tablet terminal 30 (Step 107).

If there is the book satisfying the search condition in the local database 40 (YES in Step 106), it is determined whether or not the real book 3 (physical content) and the electronic book (electronic content) are simultaneously included in the searched book (Step 108). This determination is performed, for example, by checking the “physical/electronic flag” included in the book information in the local database 40.

For example, if the book satisfying the search condition is the real book 3 and there is only one book, the process proceeds to No in Step 108, Step 109, and Step 110. On the touch panel 31 of the tablet terminal 30, information about the searched real book 3 is displayed as a search result. For example, the index of the searched real book 3 is displayed. Alternatively, detailed information such as the cover image of the real book 3 shown in FIG. 8 may be displayed.

With respect to the bookshelf 10, in the same manner as shown in FIG. 9, the projection of light on the real book 3 is controlled so that the searched real book 3 is emphasized. Thereby, the position of the searched real book 3 can be easily grasped, and the access efficiency to the real book 3 can be improved.

If there is a plurality of books satisfying the search condition and all the books are the real books 3, the process proceeds from No in Step 108 to Step 110 in the same manner. The touch panel 31 of the tablet terminal 30 displays a list of information about the plurality of searched real books 3 as the search result. For example, the indies of the plurality of real books 3 searched are displayed in a list.

With respect to the bookshelf 10, the projection of light on each book is controlled so that each of the plurality of searched real books 3 is emphasized. For example, spotlights are simultaneously applied to each of the searched real books 3. This makes it possible to easily grasp the position of each of the plurality of searched real books 3, and to improve the access efficiency to the real books 3.

If the book satisfying the search condition is the electronic book and there is only one book, the process proceeds to No in Step 108, Step 109, and Step 111. On the touch panel 31 of the tablet terminal 30, information about the searched electronic book (index and detailed information) is displayed as the search result.

With respect to the bookshelf 10, the displaying of the virtual image 4 of the electronic book is controlled so that the searched electronic book is emphasized in the same manner as shown in FIG. 11. This makes it possible to easily grasp the position of the searched electronic book (position of virtual image 4), and to improve the access efficiency to the electronic book.

If there is a plurality of books satisfying the search condition and all of them are electronic books, the process also proceeds from No in Step 108 to Step 111 in the same manner. The touch panel 31 of the tablet terminal 30 displays a list of information about the plurality of electronic books searched as the search result. For example, indices of the plurality of the electronic books searched are displayed as a list.

With respect to the bookshelf 10, the displaying of the virtual image 4 of each electronic book is controlled so that each of the plurality of electronic books searched for is emphasized. This makes it possible to easily grasp the position of each of the plurality of searched electronic books (position of each of virtual images 4), and to improve the access efficiency to the electronic books.

If there is a plurality of the books satisfying the search condition and the real book 3 (physical content) and the electronic book (electronic content) are included at the same time (YES in Step 108), the process proceeds to Step 112.

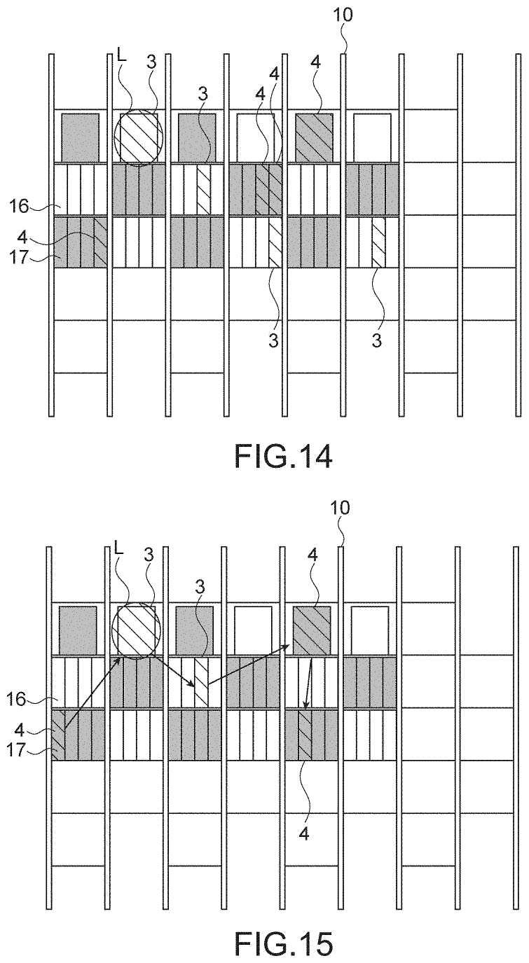

FIG. 13 is a schematic diagram showing a configuration example of a search result screen displayed on the touch panel 31 of the tablet terminal 30 in Step 112. FIG. 14 is a schematic diagram showing an example of the projection of light and image on the bookshelf 10 performed in Step 112.

As shown in FIG. 13, a search result list 72 is displayed on a search result screen 71. The search result list 72 is a list in which all indices of the real books 3 searched and all indices of the electronic books searched are listed as search results. In addition, similar to the book list 61 shown in FIG. 6, the search result list 72 is a list displayed in a status in which the real books 3 and the electronic books are mixed.

As shown in FIG. 14, with respect to the bookshelf 10, the projection of light on each book is controlled so that all of the searched real books 3 are emphasized. In addition, the displaying of the virtual image 4 of the electronic book is controlled so that all of the searched electronic books are emphasized. That is, the light and the image are projected so that both the real book 3 and the virtual image 4 are emphasized.

Note that the display position of the virtual image 4 of the searched electronic book can be changed, as appropriate. For example, the virtual image 4 of the searched electronic book may be displayed at a position close to the user 2. This makes it possible to improve the access efficiency. In addition, it is also possible to collectively display the virtual images 4 of the plurality of electronic books searched near the real book 3 to which the spotlight L is applied. Note that, in this case, the “position and coordinate data” of the electronic book information in the local database 40 is updated, as appropriate.

Note that an operation of selecting the book may be performed for the search result list 72 shown in FIG. 13 in the same manner as for the book list 61. For example, when the book is selected from the search result list 72, detailed information about the selected book is displayed in the right area 63b of the touch panel 31. With respect to the bookshelf 10, the selected book is further emphasized in a different emphasizing method from the other books already emphasized. This allows the access efficiency of the content to be improved.

In addition, any projection method capable of simultaneously emphasizing the real book 3 and the virtual image 4 may be appropriately employed.

FIG. 15 is a schematic diagram showing an example of the projection of light and an image corresponding to a scroll operation on the book list 61 of the book list screen 60. For example, it is assumed that the scroll operation is input to the book list 61 shown in FIG. 8 and FIG. 10.

In the present embodiment, it is assumed that a center focus position is fixed. Thus, in accordance with the scroll operation of the user 2, the book moved to the center focus position is sequentially changed. The instruction acceptance section 52 accepts an instruction to change a book to be selected on the basis of the scroll operation of the book list 61.

The system optimization processing section 55 respectively controls the projection of light on the real book 3 and the displaying of the virtual image 4 of the electronic book so as to follow the change of the book to be selected.

As shown in FIG. 15, in the bookshelf 10, the light and the image are projected so that the book moved to the focus position is emphasized in order. Accordingly, the spotlight L applied to the real book 3 and the virtual image 4 emphasized and displayed are moved. When the book list 61 is scrolled at high speed, positions of the spotlight L and the emphasized virtual image 4 are also moved at high speed. For example, by presenting such a visual experience, the user 2 can realize accessing the content while enjoying it. Of course, during the scrolling, it is possible to stop emphasis on the real book 3 and the electronic book. In addition, various visual experiences may be provided for accessing the content.

The displaying of the detailed information and the like on the touch panel 31 and the projection of light and image on the bookshelf 10 according to the selection instruction and the search instruction of the user 2 are ended after a predetermined time elapses. For example, if a timeout time is set in advance and when the timeout time elapses, the book list screen 60 shown in FIG. 6 is displayed. Further, the projection of the spotlight L and the emphasis displaying of the virtual image 4 are ended, and the process returns to the initial status.

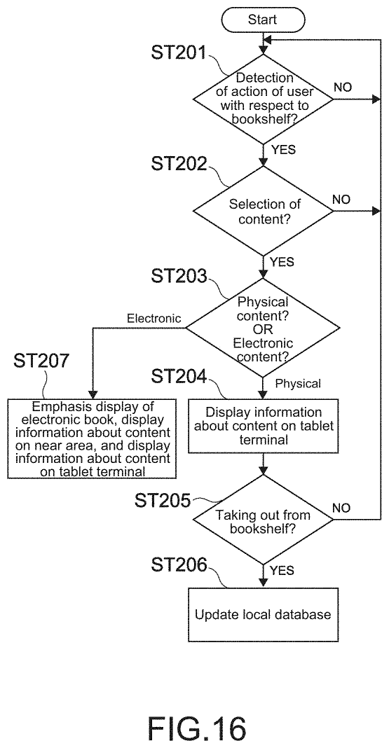

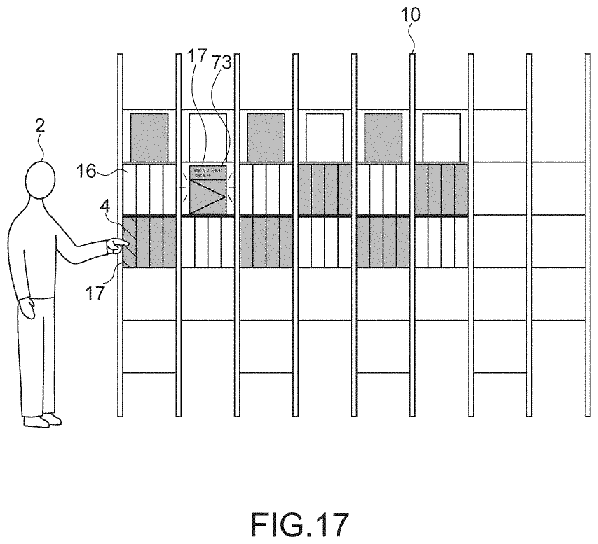

FIG. 16 is a flowchart showing an example of processing according to the action of the user 2 with respect to the bookshelf 10. FIG. 17 is a schematic diagram showing an example of the projection of light and image on the bookshelf 10 according to the action of the user 2 with respect to the bookshelf 10.

It is monitored whether or not the action of the user 2 with respect to the bookshelf 10 is detected (Step 201). In the present embodiment, the image analysis section 51 shown in FIG. 4 monitors whether or not the action of the user 2 with respect to the real book 3 arranged in the arrangement area 16 or the action of the user 2 with respect to the virtual image 4 of the electronic book displayed in the display area 17 is detected.

When the action of the user 2 is detected (Yes in Step 201), the instruction acceptance section 52 determines whether or not the selection instruction of the book (content) is accepted in accordance with the action of the user 2 (Step 202). That is, it is determined whether or not the detected action of the user 2 is an action for selecting a book.

In the present embodiment, on the basis of the action of specifying the real book 3 arranged in the arrangement area 16, the selection instruction of the specified real book 3 is accepted. Though it is not limited to which action of the user 2 is associated with the action of specifying the real book 3, for example, an action of touching the real book 3 or pointing to the real book 3 is set as the action of specifying the real book 3. That is, when the user 2 touches the real book 3 or points to the real book 3, the instruction acceptance section 52 determines that the selection instruction of the real book 3 has been input.

Further, in the present embodiment, on the basis of the action of specifying the virtual image 4 of the electronic book displayed in the display area 17, the selection instruction of the electronic book corresponding to the specified virtual image 4 is accepted. For example, an action of touching the virtual image 4 (e.g., superimposing hand, etc.) or pointing to the virtual image 4 is set as the action of specifying the virtual image 4 of the electronic book. That is, the instruction acceptance section 52 determines that the selection instruction of the electronic book is input when the user 2 touches the virtual image 4 (superimposing hand, etc.) or points to the virtual image 4.

If the selection instruction of the book is not accepted (No in Step 202), it returns to Step 201.

In a case where the selection instruction of the book is accepted (Yes in Step 202), it is determined whether or not the selected book is the real book 3 (physical content) or the electronic book (electronic content) (Step 203).

In a case where the selected book is the real book 3, information about the selected real book 3 is displayed on the touch panel 31 of the tablet terminal 30 (Step 204). For example, the book list screen 60 as shown in FIG. 8 is displayed. That is, the selected real book 3 is focused at the center and the book list screen 60 is displayed in which detailed information about the real book 3 is displayed.

Thus, in the present embodiment, the instruction of the user 2 accepted on the basis of the action of the user 2 is reflected on the book list 61. For this reason, the list information output section 53 outputs the list information so as to reflect the instruction of the user 2 reflected on the basis of the action of the user 2, as appropriate. The tablet terminal 30 displays the book list 61 on the touch panel 31 so that the instruction of the user 2 is reflected on the basis of the received list information.

The image analysis section 51 determines whether or not the selected real book 3 is taken out from the bookshelf 10 (Step 205). If the selected real book 3 is not taken out (No in Step 205), it return to Step 201. If the selected real book 3 is taken out (Yes in Step 205), the local database 40 is updated (Step 206). Specifically, the physical book information about the taken-out real book 3 is deleted from the local database 40.

If it is determined that the selected book is an electronic book in Step 203, it proceeds to Step 207.

In Step 207, as shown in FIG. 17, the displaying of the virtual image 4 of the electronic book is controlled so that the selected electronic book is emphasized. Further, detailed information 73 relating to the electronic book (i.e., selected electronic book) corresponding to the virtual image 4 specified by the user 2 is displayed in the display area 17. In the example shown in FIG. 17, the cover image of the selected electronic book is displayed as detailed information 73, but it is not limited thereto.

The detailed information 73 is typically displayed in an area near the specified virtual image 4. Accordingly, the detailed information 73 is displayed in an area near the user 2 that specifies the virtual image 4. This makes it possible to perform a similar check on the electronic book as the operation of manually checking the cover or the like of the real book 3. That is, it is possible to handle the virtual electronic book (electronic content) in a manner at intervals such that the real book 3 (physical content) is held in the hand. As a result, it becomes possible to realize very high usability. Needless to say, the display position of the detailed information 73 may be set, as appropriate.

The touch panel 31 of the tablet terminal 30 displays information about the selected electronic book (Step 207). For example, the book list screen 60 as shown in FIG. 10 is displayed. That is, the selected electronic book is focused at the center, and the book list screen 60 displaying the detailed information about the electronic book is displayed.

Note that in a case where the electronic book is selected via the book list 61 displayed on the tablet terminal 30, the detailed information 73 about the selected electronic book may be displayed in an area near the virtual image 4 of the selected electronic book. For example, it may be determined whether or not the detailed information 73 is displayed in the display area 17 of the bookshelf 10 on the basis of the size of the touch panel 31 (display) of the tablet terminal 30. For example, in a case where the size of the touch panel 31 is large, the detailed information 73 is not displayed in the display area 17, and in a case in a case where the size of the touch panel 31 is large, the detailed information 73 is displayed in the display area 17. Such processing may be adopted.

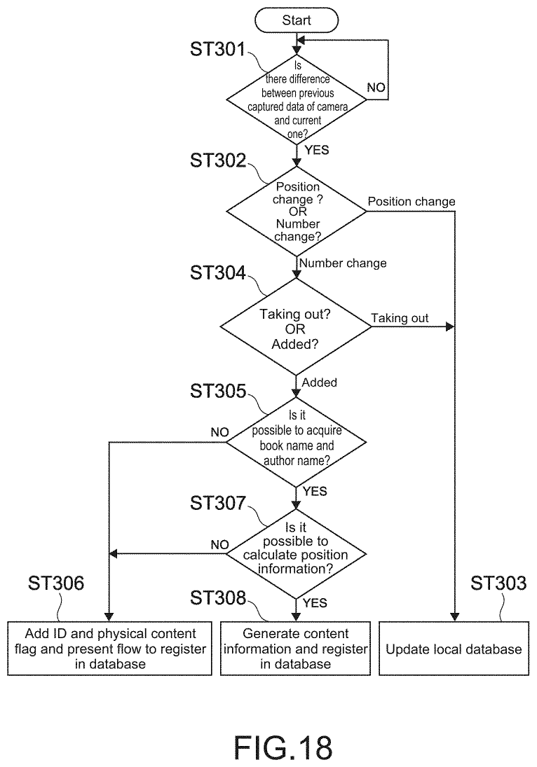

FIG. 18 is a flowchart showing an example of management of the local database 40 with respect to the real book 3.

In the present embodiment, the arrangement area 16 of the bookshelf 10 is captured periodically at predetermined time intervals. On the basis of the captured image, the arrangement status of the real book 3 arranged on the bookshelf 10 is detected. On the basis of the detected arrangement status, the physical book information is updated. For example, various update processes such as registration, change, and deletion of book information are executed.

In the example shown in FIG. 18, it is monitored whether or not there is a difference between the previous captured image (captured data) and the current captured image (Step 301).

If there is the difference between the previous captured image and the current captured image (YES in step 301), a change between the arrangement status on the basis of the previous captured image and the arrangement status on the basis of the current captured image is determined. Specifically, it is determined whether or not the position of the real book 3 has changed or the number of the real books 3 has changed (Step 302).

If the position of the real book 3 is changed with respect to the previous arrangement status, the local database 40 is updated (Step 303). Specifically, the “position/coordinate data” included in the physical book information about the real book 3 whose position is changed is updated to new position information.

In a case where the number of the real book 3 is changed with respect to the previous arrangement status, it is determined whether or not the real book 3 is taken out from the bookshelf 10 or newly added to the bookshelf 10 (Step 304). If the real book 3 is taken out from the bookshelf 10, the local database 40 is updated (Step 303). Specifically, the physical book information about the real book 3 taken out is deleted from the local database 40.

If the real book 3 is newly added to the bookshelf 10, it is determined whether or not the book name and the author name of the added real book 3 can be acquired (Step 305). As a method of acquiring the book name and the author name of the added real book 3, for example, the following method can be cited.

The book name and the author name of the added real book 3 are read from the captured image of the bookshelf 10 by an OCR (Optical Character Recognition) process or the like.

A bar code (ISBN code, book JAN code, UPC code, etc.) of the added real book 3 is read from the captured image of the current bookshelf 10 and searched through the network 1 or the like.

In a case where the added real book 3 is purchased using an online service, purchase information is referred.

For example, it is determined whether or not the book name and the author name of the added real book 3 can be acquired by performing such a method. Of course, the method is not limited to the method described above, and any method may be performed.

If the book name and author name of the added real book 3 cannot be obtained (No in Step 305), the ID and the physical content flag are provided. Then, the touch panel 31 of the tablet terminal 30 presents a flow for registering the physical book information about the added real book 3 in the local database 40 (Step 306). The user 2 performs an operation for storing each information shown in FIG. 5, and the physical book information is registered.

If the book name and the author name of the added real book 3 can be acquired (Yes in Step 305), it is determined whether or not the position information about the added real book 3 can be calculated from the captured image of the current bookshelf 10 (Step 307). If the position information about the added real book 3 cannot be calculated (No in Step 307), a flow for registering the physical book information about the added real book 3 is presented (Step 306).

If the position information about the added real book 3 can be calculated (Yes in Step 307), the physical book information about the added real book 3 is generated and registered in the local database 40 (Step 308).

Note that the items other than the “book name”, “author name” and “position/coordinate data” of the physical book information are generated by the data management section 54 or the like, as appropriate. If there is any item that cannot be generated, the item is blank and the physical book information is generated. Of course, it is determined whether or not each item can be generated, and if it cannot be generated, a flow for registration may be presented to the user 2.

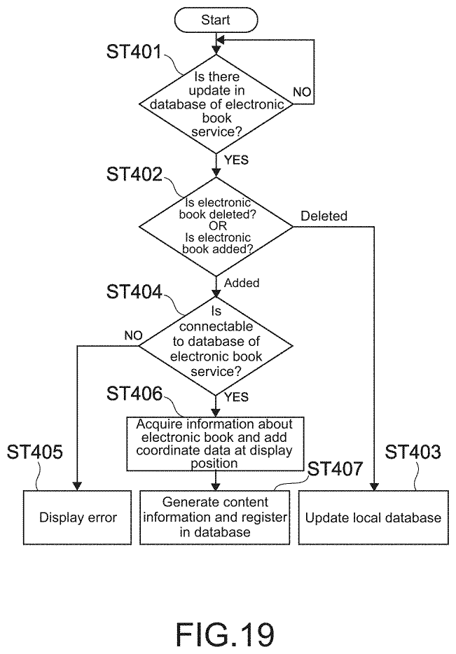

FIG. 19 is a flowchart showing an example of management of the local database 40 relating to the electronic book.

In the present embodiment, the information about an acquisition status of the electronic book is acquired from the servers 90a and 90b of the network service for providing the electronic book (hereinafter referred to as electric element book service) shown in FIG. 1. On the basis of the acquired information about the acquisition status, the electronic book information is updated.

In the example shown in FIG. 19, it is monitored whether or not there is an update in the database of the electronic book service (Step 401). For example, it is assumed that the user 2 purchases the electronic book from the electronic book service without using the content presentation system 100. Alternatively, it is assumed that there is the electronic book whose browsable period has elapsed.

In such a case, the server of the electronic book service notifies the system controller 50 of the update of service use information or the like of the user 2. It is needless to say that the system controller 50 may periodically inquire of the server of the electronic book service whether or not the service use information or the like is updated. Note that the service use information and the like of the user 2 is information included in the information about the acquisition status of the electronic book.

If there is the update in the database of electronic book service (Yes in Step 401), it is determined whether or not the electronic book is deleted or the electronic book is added (Step 402). If the electronic book is deleted, the local database 40 is updated (Step 403). Specifically, the electronic book information about the deleted electronic book is deleted from the local database 40.

If the electronic book is added, it is determined whether or not the local database 40 is connectable to a database of the electronic book service (Step 404). The method of connecting to the databases is not limited, and any method may be used.

If the connection to the database of the electronic book service is not possible (No in Step 404), an error is displayed on the touch panel 31 of the tablet terminal 30 (Step 405). Content of the error may vary depending on reasons such as a utility form of the electronic book of the electronic book service (download version, online version, or the like) and incapability of connecting to the databases.

For example, as the electronic book information about a newly added electronic book cannot be generated, there may be an error status in which the electronic book information cannot be added to the content presentation system 100. Alternatively, there may be an error status in which all electronic books included in the electronic book service where the databases are not connected cannot be browsed. In this case, the electronic book information about the electronic books included in the electronic book service is deleted from the local database. In Step 405, the error corresponding to the error status occurring is displayed, as appropriate.

If it is possible to connect to the database of the electronic book service (Yes in Step 404), information about the newly added electronic book (information about acquisition status) is acquired. In addition, coordinate data at a position for displaying the virtual image 4 of the newly added electronic book is added (Step 406). Then, electronic book information about the added electronic book is generated and registered in the local database 40 (Step 307). Of course, the information included in the electronic book information may be collected again by a search or the like on the basis of the information acquired in Step 307.

As described above, in the content presentation system 100 according to the present embodiment, the physical book information about the real book 3 and the electronic book information about the electronic book are stored. The projection of light on the real book 3 arranged in the arrangement area 16 of the bookshelf 10 and the displaying of the virtual image 4 of the electronic book on the display area 17 corresponding to the arrangement area 16 are respectively controlled. As a result, the access efficiency for content of both the real book 3 and the electronic book can be improved.

In a case where both the real books 3 (physical content) and the electronic books (electronic content) are owned, the real books 3 and the electronic books are managed separately in the past, and the content has to be selected and searched separately.

In the present embodiment, the book list 61 in which the real books 3 and the electronic books are mixed is displayed. In addition, the real books 3 and the virtual images 4 of the electronic books in the bookshelf 10 exist in a mixed state and can be equally accessed. This makes it possible to seamlessly handle the real books 3 and the electronic books by the user 2, and high usability can be achieved.

The user 2 can handle own books equally without being aware of the real book or the electronic book. As a result, it becomes possible to select or search selection desired content without being aware of the boundaries between real and digital. This results in a very valuable content presentation.

### OTHER EMBODIMENTS

The present technology is not limited to the embodiments described above, and can achieve various other embodiments.

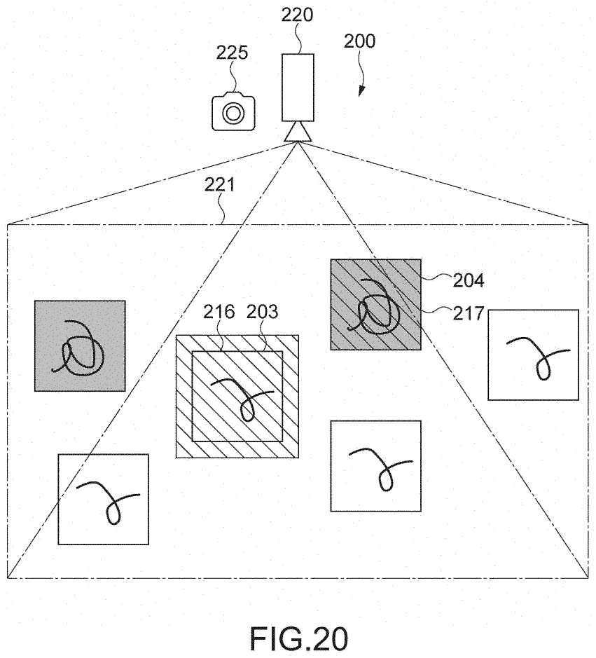

FIG. 20 is a schematic diagram for explaining a content presentation system according to another embodiment. In a content presentation system 200, a tag that can be affixed to a wall or the like is presented as the content.

For example, an actual tag 203 is attached (arranged) to a predetermined area such as a wall as a first area 216. The first area 216 can be arbitrarily set in a projection area 221 of a projector 220.

In a second area 217 different from the first area 216, a virtual image 204 of an electronic tag is displayed. Typically, the information about the actual tag 203 attached in the past is digitized and stored. The digitized tag becomes an electronic tag. Further, an image in which the actual tag 203 attached in the past is captured is displayed in the second area 217 of the electronic tag as the virtual image 204. As a result, it becomes possible to present the tag attached up to the present comprehensively and to exhibit high usability.

For example, it is possible to select or search the tag in accordance with a name of a person who created the tag (actual tag 203 and electronic tag), a time period when the tag is attached, content written on the tag, etc. As shown in FIG. 20, the projection of light on the actual tag 203 is controlled so that the selected or searched actual tag 203 is emphasized. The displaying of the virtual image 204 of the electronic tag is controlled so that the selected or searched electronic tag is emphasized.

It is also possible to detect the action of the user with respect to the tag on the basis of the captured image captured by the camera 225. In accordance with the instruction of the user based on the action of the user, the projection of light on the actual tag 203 and the displaying of the virtual image 204 of the electronic tag are controlled, as appropriate.

In addition, various processes described above, such as displaying of an attachment list or the like, the projection of light according to the instruction of the user via the attachment list and displaying of the image can be applied to the tag.

As described above, the present technology is applicable to various types of content. For example, the present technology is also applicable to music content and video content. In this case, a case of a storage medium such as a record, a CD (registered trademark), a DVD (registered trademark), and a Blu-rayDisc (registered trademark) in which the music content or the video content is stored can be arranged as the physical content. As the virtual image of the electronic content corresponding to the physical content, the virtual image of the case of the storage medium can be used.

In the above, the camera is arranged to detect the action of the user. It is not limited thereto and other sensor device such as a distance measuring sensor may be used instead of or in addition to the camera.

In the above description, the content is presented to the single user 2. It is not limited to the single user 2 and the content presentation system according to the present technology may be used by a plurality of users at the same time. For example, the projection of light for emphasis and the displaying of the virtual image are made different for each user. This allows each user to simultaneously access the content.

A way to set the first area in which the physical content is arranged and the second area in which the image relating to the electronic content is displayed is not limited and may be arbitrarily set.

In the above, as the projection of light on the physical content and the image relating to the electronic content, the projection of light and the projection of image are performed by the projector or the like. It is not limited thereto, and the image relating to the electronic content may be displayed on a transparent screen or the like. That is, the virtual image of the electronic content or the like may be displayed on the display panel or the like arranged in the second area.

The system controller and the projector described above may be integrally configured. In other words, the projector projecting light may have functions of the system controller. In this case, the projector serves as an embodiment of the information processing apparatus according to the present technology.

The information processing method and the program according to the present technology can be executed not only in a computer system including a single computer, but also in a computer system in which a plurality of computers operates cooperatively. Note that, in the present disclosure, a system refers to a set of components (such as apparatuses and modules (parts)) and it does not matter whether or not all of the components are in the same housing. Therefore, a plurality of apparatuses housed in separate casings and connected to one another via a network, and a single apparatus having a plurality of modules housed in a single casing are both the system.

The information processing method and the program according to the present technology are executed by a computer system, for example, using a single computer that controls the projection of light on the physical content, displays the image relating to the electronic content, accepts the instruction of the user, outputs the list information, and the like, or using different computers that execute respective processes, both of which cases are included. Further, the execution of each process by a specified computer includes causing another computer to execute a portion of or all of the process and acquiring a result thereof.

In other words, the information processing method and the program according to the present technology are also applicable to a configuration of cloud computing in which a plurality of apparatuses shares a single function and collaboratively processes the single function through a network.

The content presentation system, the system controller, the system presentation area, the configurations of the respective screens, the flow of content presentation, and the like explained with reference to the drawings are only one embodiment, and can be arbitrarily modified without departing from the spirit of the present technology. In other words, for example, any other configurations or algorithms for practicing the present technology may be adopted.

In the present disclosure, the expression using “substantially” such as “substantially equal interval” or “substantially equal” is a concept meaning a predetermined range (for example, a range of ±10%) on the basis of “completely equal interval” or “completely equal” or the like. It is also possible to express these simply without “substantially” such as “equal interval” or “equal”.

At least two of the features of the present technology described above can also be combined. In other words, various features described in the respective embodiments may be combined discretionarily regardless of the embodiments. Further, the various effects described above are not limitative but are merely illustrative, and other effects may be provided.

The present technology may also have the following structures.

(1) An information processing apparatus, including:

a storage section that stores first content information about physical content arranged in a first area and second content information about electronic content; and

a display control section that respectively controls a projection of light on the physical content and a displaying of an image relating to the electronic content on a second area corresponding to the first area on the basis of the stored first and second content information.

(2) The information processing apparatus according to (1), in which

the physical content is arranged in a predetermined space,

the first area and the second area are areas within the predetermined space,

the image relating to the electronic content is an image that shows virtual content expressed as an image of a same type as the physical content in the predetermined space, and

the display control section respectively controls the projection of light on the physical content in the predetermined space and a projection of the image relating to the electronic content in the predetermined space.

(3) The information processing apparatus according to (1) or (2), further including:

an acceptance section that accepts an instruction of a user with respect to the physical content and the electronic content, in which

the display control section respectively controls the projection of light on the physical content and the displaying of the image relating to the electronic content on the basis of the accepted instruction of the user.

(4) The information processing apparatus according to (3), in which

the acceptance section accepts a selection instruction of content, and

the display control section controls the projection of light on the physical content such that the selected physical content is emphasized when the physical content is selected, and controls the displaying of the image relating to the electronic content such that the selected electronic content is emphasized when the electronic content is selected.

(5) The information processing apparatus according to (3) or (4), in which

the acceptance section accepts a search instruction of content, and

the display control section controls the projection of light on the physical content such that the searched physical content is emphasized, and controls the displaying of the image relating to the electronic content such that the searched electronic content is emphasized.

(6) The information processing apparatus according to any one of (3) to (5), further including:

an output section that outputs list information for displaying a list including the physical content and the electronic content, in which

the acceptance section accepts the instruction of the user on the basis of an operation of the user on the list displayed on a display.

(7) The information processing apparatus according to (6), in which

the list is a list displayed in a status in which the physical content and the electronic content are mixed.

(8) The information processing apparatus according to (6) or (7), in which

the acceptance section accepts an instruction to change content to be selected on the basis of a scroll operation on the list,

the display control section respectively controls the projection of light on the physical content and the displaying of the image relating to the electronic content so as to follow the change of the content to be selected.

(9) The information processing apparatus according to any one of (3) to (8), in which

the acceptance section accepts the instruction of the user on the basis of an action of the user with respect to the physical content arranged in the first area and an image relating to the electronic content displayed in the second area.

(10) The information processing apparatus according to (9), in which

the acceptance section accepts, on the basis of an action of specifying the physical content arranged in the first area, a selection instruction of the specified physical content, and accepts, on the basis of an action of specifying the image relating to the electronic content displayed in the second area, a selection instruction of the electronic content corresponding to the specified image.

(11) The information processing apparatus according to (10), in which

the display control section displays detailed information about the electronic content corresponding to the specified image in the second area.

(12) The information processing apparatus according to any one of (6) to (8), in which

the acceptance section accepts the instruction of the user on the basis of an action of the user with respect to the physical content arranged in the first area and an image relating to the electronic content displayed in the second area, and

the output section outputs the list information such that the accepted instruction of the user on the basis of the action of the user is reflected in the list.

(13) The information processing apparatus according to any one of (1) to (12), in which

the first and second content information is stored in the storage section in a data format including at least information about a position where content is arranged, information indicating whether or not content is physical content or electronic content, and meta information about content,

the first content information includes information about a position where the physical content is arranged, information indicating the physical content, and meta information about the physical content, and

the second content information includes information about a position where an image relating to the electronic content is displayed, information indicating the electronic content, and meta information about the electronic content.

(14) The information processing apparatus according to any one of (1) to (13), further including:

a management section that manages the first and second content information.

(15) The information processing apparatus according to (14), in which

the management section detects an arrangement status of the physical content on the basis of a captured image in which the first area is captured, and updates the first content information on the basis of the detected arrangement status.

(16) The information processing apparatus according to (14) or (15), in which

the management section acquires information about an acquisition status of the electronic content from a server of a network service that provides the electronic content, and updates the second content information on the basis of information about the acquired acquisition status.

(17) The information processing apparatus according to any one of (1) to (16), in which

the electronic content is a book, a case of a recording medium, or a tag.

(18) An information processing method executed by a computer system, including:

storing first content information about physical content arranged in a first area and second content information about electronic content; and

respectively controlling a projection of light on the physical content and a displaying of an image relating to the electronic content on a second area corresponding to the first area on the basis of the stored first and second content information.

(19) A program executed by a computer system, the program causing the computer system to perform the following steps:

storing first content information about physical content arranged in a first area and second content information about electronic content;

respectively controlling a projection of light on the physical content and a displaying of an image relating to the electronic content on a second area corresponding to the first area on the basis of the stored first and second content information.

### REFERENCE SIGNS LIST

2 user
3 real book
4 virtual image of electronic book
10 bookshelf
16 arrangement area
17 display area
20, 220 projector
25, 225 camera
30 tablet terminal
31 touch panel
40 local database
50 system controller
51 image analysis section
52 instruction acceptance section
53 list information output section
54 data management section
55 system optimization processing section
61 book list
64 detailed information
100, 200 content presentation system
203 tag
204 virtual image of electronic tag

1. An information processing apparatus, comprising:
a storage section that stores first content information about physical content arranged in a first area and second content information about electronic content; and
a display control section that respectively controls a projection of light on the physical content and a displaying of an image relating to the electronic content on a second area corresponding to the first area on a basis of the stored first and second content information.

2. The information processing apparatus according to claim 1, wherein
the physical content is arranged in a predetermined space,
the first area and the second area are areas within the predetermined space,
the image relating to the electronic content is an image that shows virtual content expressed as an image of a same type as the physical content in the predetermined space, and
the display control section respectively controls the projection of light on the physical content in the predetermined space and a projection of the image relating to the electronic content in the predetermined space.

3. The information processing apparatus according to claim 1, further comprising:
an acceptance section that accepts an instruction of a user with respect to the physical content and the electronic content, wherein
the display control section respectively controls the projection of light on the physical content and the displaying of the image relating to the electronic content on a basis of the accepted instruction of the user.

4. The information processing apparatus according to claim 3, wherein
the acceptance section accepts a selection instruction of content, and
the display control section controls the projection of light on the physical content such that the selected physical content is emphasized when the physical content is selected, and controls the displaying of the image relating to the electronic content such that the selected electronic content is emphasized when the electronic content is selected.

5. The information processing apparatus according to claim 3, wherein
the acceptance section accepts a search instruction of content, and
the display control section controls the projection of light on the physical content such that the searched physical content is emphasized, and controls the displaying of the image relating to the electronic content such that the searched electronic content is emphasized.

6. The information processing apparatus according to claim 3, further comprising:
an output section that outputs list information for displaying a list including the physical content and the electronic content, wherein
the acceptance section accepts the instruction of the user on a basis of an operation of the user on the list displayed on a display.

7. The information processing apparatus according to claim 6, wherein
the list is a list displayed in a status in which the physical content and the electronic content are mixed.

8. The information processing apparatus according to claim 6, wherein
the acceptance section accepts an instruction to change content to be selected on a basis of a scroll operation on the list,
the display control section respectively controls the projection of light on the physical content and the displaying of the image relating to the electronic content so as to follow the change of the content to be selected.

9. The information processing apparatus according to claim 3, wherein
the acceptance section accepts the instruction of the user on a basis of an action of the user with respect to the physical content arranged in the first area and an image relating to the electronic content displayed in the second area.

10. The information processing apparatus according to claim 9, wherein
the acceptance section accepts, on a basis of an action of specifying the physical content arranged in the first area, a selection instruction of the specified physical content, and accepts, on a basis of an action of specifying the image relating to the electronic content displayed in the second area, a selection instruction of the electronic content corresponding to the specified image.

11. The information processing apparatus according to claim 10, wherein
the display control section displays detailed information about the electronic content corresponding to the specified image in the second area.

12. The information processing apparatus according to claim 6, wherein
the acceptance section accepts the instruction of the user on a basis of an action of the user with respect to the physical content arranged in the first area and an image relating to the electronic content displayed in the second area, and
the output section outputs the list information such that the accepted instruction of the user on a basis of the action of the user is reflected in the list.

13. The information processing apparatus according to claim 1, wherein
the first and second content information is stored in the storage section in a data format including at least information about a position where content is arranged, information indicating whether or not content is physical content or electronic content, and meta information about content,
the first content information includes information about a position where the physical content is arranged, information indicating the physical content, and meta information about the physical content, and
the second content information includes information about a position where an image relating to the electronic content is displayed, information indicating the electronic content, and meta information about the electronic content.

14. The information processing apparatus according to claim 1, further comprising:
a management section that manages the first and second content information.

15. The information processing apparatus according to claim 14, wherein
the management section detects an arrangement status of the physical content on a basis of a captured image in which the first area is captured, and updates the first content information on a basis of the detected arrangement status.

16. The information processing apparatus according to claim 14, wherein
the management section acquires information about an acquisition status of the electronic content from a server of a network service that provides the electronic content, and updates the second content information on a basis of information about the acquired acquisition status.

17. The information processing apparatus according to claim 1, wherein
the electronic content is a book, a case of a recording medium, or a tag.

18. An information processing method executed by a computer system, comprising:
storing first content information about physical content arranged in a first area and second content information about electronic content; and
respectively controlling a projection of light on the physical content and a displaying of an image relating to the electronic content on a second area corresponding to the first area on a basis of the stored first and second content information.

19. A program executed by a computer system, the program causing the computer system to perform the following steps:
storing first content information about physical content arranged in a first area and second content information about electronic content;
respectively controlling a projection of light on the physical content and a displaying of an image relating to the electronic content on a second area corresponding to the first area on a basis of the stored first and second content information.
